(19) United States
(12) Patent Application Publication
(10) Pub. No.: US 2023/0055092 A1
(43) Pub. Date: Feb. 23, 2023

(54) METHODS AND SYSTEMS FOR CONTROLLING PERNICIOUS LIES IN DIGITAL MEDIA

(71) Applicant: Antique Books, Inc., Pittsburgh, PA (US)

(72) Inventor: Robert H. Thibadeau, SR., Pittsburgh, PA (US)

(21) Appl. No.: 17/793,857

(22) PCT Filed: Feb. 7, 2020
(86) PCT No.: PCT/US2020/017258

§ 371 Date: Jul. 19, 2022

Related U.S. Application Data
(60) Provisional application No. 62/842,546, filed on May 3, 2019.

(51) Int. Cl. G06F 21/64

(52) U.S. Cl. CPC G06F 21/64

(57) ABSTRACT

Methods and systems for controlling pernicious lies in digital media are provided. A system server provides enforced moderated dialogue on the suspected lies in the form of a new type of private court. The system provides a way to identify and document lies, and gathering court participants. The system also provides a way of adjudicating the suspected lies through specific questions. Finally, the system provides a way of publishing verdicts. The system provides a method of incorporating Artificial Intelligence modules that can replace the specified human activities. One major advantage is that the present methods and systems are backed by science and history that provides an optimum, if nevertheless still imperfect, solution to the problem. It also provides a solution that can be near real time on the first appearance of an instance of lying deceit.

### RELATED APPLICATIONS

This application claims the benefit of provisional patent application Ser. No. 62/842,546, filed May 3, 2019, the disclosure of which is hereby incorporated herein by reference in its entirety.

### FIELD OF THE DISCLOSURE

The present disclosure relates to a computing system that manages the discovery and interpretation of information on the Internet and digital media in general.

### BACKGROUND

Lies, misinformation, and disinformation have infested the Internet, social media, and other digital media. As a result, there are many methods and systems that have been suggested and implemented to control the dissemination of these lies or to control their harm. However, each of these fails to fully remedy the situation. As such, improved methods and systems for identifying the pernicious lies and neutralizing their pernicious effects are needed.

### SUMMARY

Methods and systems for controlling pernicious lies in digital media are provided. This provides novel methods and systems that have advantages over many other methods and systems in identifying the pernicious lies and neutralizing their pernicious effects. In some embodiments, a system server on the Internet provides a solution to managing lies, misinformation, disinformation on the Internet, social media, and other media. In some embodiments, the system provides enforced moderated dialogue on the suspected lies in the form of a new type of private court. It provides a way to identify and document lies, gathering court participants including, for example: plaintiff, judge, and jury. The system also provides a way of adjudicating the suspected lies through specific questions. Finally, the system provides a way of publishing verdicts to existing Internet services, social media, and other media, for example. Furthermore, in some embodiments, the system provides a method of incorporating Artificial Intelligence modules that can replace the specified human activities with fully automated machine activities in a portion of the cases brought to the court.

One major advantage is that the present methods and systems are backed by science and history that provides an optimum, if nevertheless still imperfect, solution to the problem. It is optimum in that no alternative is known that can provide more coverage of lying deceit in all forms than the present one. It also provides a solution that can be near real time on the first appearance of an instance of lying deceit.

In some embodiments, a method and system for identifying, explaining, and distributing the consensual truth of suspected lies, misinformation, and disinformation in digital media. In some embodiments, a parallel manual and automated step enables improving automation while sustaining auditability, and conversely, using the sequence of manual events to train the automation.

Some embodiments structure dialogue about suspected lies, misinformation, and disinformation in digital media to rapidly perform the steps, whether manual or automated.

Some embodiments assure anonymity of humans participating in the court.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 shows a means of placing any lie, at time t, into a taxonomy of lies, according to some embodiments of the present disclosure;

FIG. 2 illustrates a case proceeding through three states involving six operations, according to some embodiments of the present disclosure;

FIG. 3 shows the basic case flow operation incorporating the options for machine or human participation, according to some embodiments of the present disclosure;

FIG. 4 demonstrates the operation of making explicit the lie and factual contextual markup, according to some embodiments of the present disclosure;

FIG. 5 illustrates a trial questionnaire, according to some embodiments of the present disclosure;

FIG. 6 shows the Learned Classifications for the machine learning automation, according to some embodiments of the present disclosure;

FIG. 7 shows the operation of the machine learning and natural language systems modules employed, according to some embodiments of the present disclosure;

FIG. 8 shows the operation of the special class action case, according to some embodiments of the present disclosure;

FIG. 9 provides an operation to require humans have globally unique email addresses which insures the system has a means to confirm they are human or reasonably known to be human in operation, according to some embodiments of the present disclosure;

FIG. 10 is a schematic block diagram of a computation node 1000, according to some embodiments of the present disclosure;

FIG. 11 is a schematic block diagram that illustrates a virtualized embodiment of the computation node 1000, according to some embodiments of the present disclosure; and

FIG. 12 is a schematic block diagram of the computation node 1000, according to some other embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The Science of Folk Lies

The science of lies [1][2][3] is a cognitive science, and, more specifically, a computational cognitive neuroscience. Further information can be found in Thibadeau, Robert. “How to Get Your Privacy Back” Pittsburgh, Pa.: Privust Publishing LLC, June, 2018. Reg. U.S. Copyright #TX8-575-845, May 17, 2018 (referred to herein as [1]). Further information can be found in Thibadeau, Robert. “How to Get Your Lies Back: The Internet Court of Lies.” Pittsburgh, Pa.: Privust Publishing LLC, May 2019. Reg. U.S. Copyright #TX8-724-655, Mar. 27, 2019 (referred to herein as [2]). Further information can be found in Thibadeau, Robert. “Fiat Lies are Genocide on the Human Race.” Medium.com, September, 2019. Free public link: https://medium.com/@rhtcmu/https-medium-com-rhtcmu-fiat-lies-are-genocide-on-the-human-race-a4d76b093530?source=friends_link&sk=def42b91e45b457ef3abc64ab440c8ae (referred to herein as [3]).

Lying in human natural language communication has not only greatly increased human survival value among humans, but has also greatly increased human destructive power among humans. A human natural language is any language a normal human baby learns normally to speak and understand. Lying is a universal of all human natural languages [2].

To reduce ambiguity, we can assume a set theoretic definition of a lie (or cognitive episode of misinformation, or cognitive episode of disinformation). Conveniently, this definition is already accepted worldwide as signaling a lie. A lie is accepted as the opposite of a truth where the truth is:
1) the truth;
2) the whole truth; and
3) nothing but the truth.

A lie is defined in set theory terms against a single word-concept universal of truth. Lying is not, for example, an incomplete list of derivatives of lying such as fraud, misrepresentation or even misinformation or disinformation even though they are all based on this fundamental understanding of a lie.

Folk, or conversational, lies are what people generally talk about. Additional information can be found in [1][2][3] and A. Wiegmann and J. Meibauer, “The folk concept of lying,” Philosophy Compass, 2019 (referred to herein as [4]). These are untruths where there is variously a deceit, an intention to deceive, and a motive behind the intention to deceive. A lie is pernicious when a deceit succeeds in misleading someone about the truth, possibly causing harm, because the deceit is not known.

Not all folk lies are pernicious. Not all lies hide deceit with pernicious intention and motivation. For example, everyone knows the “fiction” label that socially permits lying without hiding the deceit.

A method and system must be able to distinguish and handle such lies and weigh their pernicious deceit accordingly. For example, in a particular case, it may only be necessary to label a lie as “fiction” in order to eliminate its pernicious deceit. There are many other such examples of lies occurring in social context that are thereby admitted as lies and found socially acceptable, if not actually desirable [2].

The fact that a folk lie can be labelled as a lie, with its deceit and motive made known, suggests lies can have their pernicious aspect removed if the deceit and motive is, in fact, known. This is the basis for neutralizing pernicious lies in the present invention [2].

Non-Linguistic Folk Lies

Science suggests that natural language is the most perfect ‘window’ on the neocortical brain, but it is the intermodal brain that computes truth and lies. Lies are not inherent in the computation of English or any other natural language. They are not restricted to the sensory motor modalities of human speech.

The lies are not in the language, they are an intrinsic part of how we think: how our intermodal brains compute. Our intermodal brains compute in intermodal episodes which we can witness or lie about. A picture can be a lie. A shot in a movie can be a lie. An action by a person can be a lie. Even a smile can be a lie.

What is special about human speech is the ability to communicate any kind of lie that we can imagine. Animals without human speech may be able to conceive lies but cannot communicate truth and lies as well as humans can using human natural language communication capabilities.

We are fortunate that because natural language can communicate any lie through any sensory motor modality that we find we use the natural language properties of lies to explore lies in any modality. Indeed, a property of intermodal thought is that we can think about how we think and reason. We can even lie about what we think and reason, and we can do this in our natural language.

From this observation comes the most significant finding about human lies. The terms “sentence” and “episode” are used interchangeably. A sentence is both an episode, itself, which the brain can witness as truly asserted, and describes an intermodal episode that the brain recognizes and can verify as truth or lie as well.

We have long known that truth to a person is based on what he knows: his episodic memories. No two people can possibly have the same memories since no two people have exactly the same experiences. This means that truth to one person can easily be interpreted as a lie to another even though the cognitive computations for truth and lies are universal.

In language, our cognitive episodes are arranged hierarchically in predications composed of predicates modifying subjects. But in our intermodal brains we do not know how predications are organized and computed. We do know they are episodic. We do know that to speak or act we must compose our episodic predications into episodic hierarchies of predications for communicating with others.

But more important, the predication capability of thought and memory leads to another language universal which extends to all a perceptions and assertions, all sensory motor intermodal processing: Any sentence can be a lie.

The simple inductive proof is that any normal human can readily preface any sentence with “It is a lie that” and follow it with “because X” with X constructed to be a plausible context for that sentence to be a lie. The proof is that this is true of the episode conveyed in any sentence that a human can communicate [2][3].

Predication context can always alter the communicated episode by reorienting human episodic memories applied to the assertion to a different conceptual context. The cognitive neuroscience currently points this intermodal predication-processing function principally to a neocortical function that spans the entire neocortex and possibly other brain structures as well [2].

This means, quite simply, that there is no signal in any finite sentence (or modal episode) that can prove the sentence (or modal episode) is a lie or not.

This has radical implications for the success of other technologies over the present invention.

Since two people can, and most often do, speak and understand a sentence with regard to different context, then there is no way, without cooperation by both parties, to reveal whether a sentence is a lie.

This means that any machine interpretation that attempts to find lies will be inferior to human interpretation, at least with anything like current technology. This inferiority will continue because of our limited knowledge about how the human neocortex computes predications, and how episodic memories are organized and stored. We are still far from knowing how to build a human brain.

The most comprehensive means that humans have available to discover what sentences are lies and what sentences are truths is their natural language. We use our language to ask questions of suspected liars and listen to their answers and to align our understandings and perhaps discover any pernicious deceit. In effect, lies are most optimally exposed through human natural language dialogue.

Truth is central to the alignment of truth among two people. If two people can agree on what they believe is true, they can generally agree on what sentences are lies in that predication context.

The intermodal brain also knows how it acquires its episodic intermodal knowledge. The most fundamental truth comes when two people can witness the same truth. This is the basis for modern science. Direct witnessing is also the basis for Rules of Evidence in law.

This is the basic, inescapable, computational cognitive neuroscience behind the present invention [2][3].

Fiat Lies

A broad, if not vast majority, class of lie instances in digital media is called “Fiat Lies” [2][3]. Fiat lies are defined as episodic assertions of any sensory motor form, spoken, written, seen, heard, or acted, among others, that are suspected by a person to be a lie, but for which dialogue with the liar is infeasible for any reason.

Fiat lies have long been with humanity but with technologies beginning thousands of years ago such as signaling, writing, print, radio and TV broadcasting, and the Internet, fiat lies have become more destructive to larger populations than before. Additional information can be found in [1][2][3][4] and Wylie, Christopher. Mindf*ck: Cambridge Analytica and the Plot to Break America. Great Britain, Profile Books Ltd, 2019 (referred to herein as [5]).

Because dialogue with the liar is not feasible, then a suspect lie cannot be exposed as to its true deceit, intention, and motivation. It is just a guess. Even the truth of the assertion is a guess. Thus, the purpose of the present invention is to convert fiat lies into folk lies where the lies, if any, have some agreement among people with whom dialogue is possible.

The science says that the optimal way to convert fiat lies into conversational, or folk, lies, is to have every person who suspects a lie dialogue directly, person to person, in natural language, with the suspected liar for an indefinite period of time.

Thus every fiat lie requires a separate, indefinitely long, verbal communication, in natural language, between the liar and the person who suspects the assertion is a lie in order to neutralize the pernicious effect of the lie.

This is an N−1 problem for every lie where N is the total population people who heard, read, watched, or otherwise experienced the fiat lie on media. The −1 is the suspected liar. This is also, of course, an exponential problem as the number of liars, and the repeats of their lies, increase across the media.

There are simply too many N−1 first-hand dialogues required to neutralize the potential harm of every fiat lie signaled, written, printed, messaged, radio or TV broadcast, and any other digital media in general. This N−1 number is not only often infeasible, it is often practically impossible during the human lifetime of a suspected liar who only apparently lies once, let alone thousands of times.

Digital media distribution of communication content in any modality rarely affords direct dialogue. The consequence is that Fiat Lies by the very fact of lack of appropriate context and feedback become destructive. This has been known in common experience for many centuries, but the science, why it is true, is only recently understood.

The science is very clear about the most optimal means of dealing with fiat lies in digital media. But new systems and methods need to be created because the science requires impossibly infeasible methods and systems to achieve optimality.

The new methods and systems must approximate the cognitive functions of the infeasible methods and systems in order to approach optimality. They must incorporate human natural language dialogue when other methods may fail.

Courts Convert Fiat Lies Into Folk Lies

A historically successful solution to these predication context and N−1 feedback problems with neutralizing the damage of fiat lies in human society are courts.

Courts historically implement the necessary and sufficient natural language dialogue. Indeed, any court can be defined as an episode that enforces moderated human dialogue concerning a fiat lie with the objective to exposing any fiat lie as a conversational folk lie.

This conversion between fiat and folk lie is by definition. A fiat lie is one where dialogue about the lie is infeasible, and a folk lie is, by definition, dissected through dialogue. All courts do this whether the courts are sovereign courts or private courts and both types of courts have existed for thousands of years.

In the Age of Enlightenment or Reason four hundred years ago, the Rules of Evidence in court were developed to help shape the natural language dialogue required to distinguish truth from lies [2][3].

Courts handle the N−1 problem by assigning the task of uncovering the lie to a smaller number of people who dialogue about the fiat lies and whose verdicts represent the truth to others who are suspicious of the assertions being made. In the case of sovereign courts, humans may be found at fault or at no fault for their deceits or lack thereof.

Because the present method and system uses this socially understood court concept, we use the term “court” and other familiar terms.

We employ terms for participants in the court to include a plaintiff for the person or machine that reports a fiat lie to the court, and a judge or machine and jury or machine that fixes a verdict for the fiat lie. But the present method and system are further distinguished in ways not associated with any known sovereign or private court.

The present method and system is colloquially termed with the trademark “Internet Court of Lies.”

Internet Court of Lies

The present method and system is embodied in an advanced, automated, case management system for a private court of lies which uniquely combines rapid human discovery, judgement, and disposition of fiat lies.

One embodiment of the Internet Court of Lies is implemented on the Internet at https://www.liecourt.com. This one employs server additions and modifications on the open source MediaWiki codebase from the Wikipedia Foundation.

The properties that make the Internet Court of Lies unique from known sovereign courts are that:
1) Fiat lies, not people, are the subject of the court;
2) A fiat lie and its context are plainly visible to all because we assume the Internet provides the evidence of its existence;
3) Anyone can be a direct witness to the fiat lie and the truths that can expose it as a folk lie;
4) The liar need not be present for dialogue;
5) The verdict asserts the truths and untruths, the deceits, the intentions, and motivations judged for the folk lies exposed and their judged likelihoods.
6) All the humans participating in the courts are anonymized on a per court case basis.

A claim of the present invention is that it can provide a means to improve technology to the point where lies can be identified at least as well as humans can identify them, and with the various positive attributes of machines, perhaps more consistently, and with better estimates of likelihood, than any particular group of humans such as a court can.

The present method and system employs a number of components to retain human dialogue at critical junctures. The components rely in great measure on the known fact in experimental cognitive science that cognitive behavior is almost always normally distributed with strong agreement.

In other words, a sample of people can accurately predict cognitive outcomes among the population. We see the success of this in sovereign law specifically in the historical development of courts and other assemblies. The present system develops a new kind of court system while retaining its basic power in dealing with the N−1 problem in dealing with fiat lies.

The core roles in this court are “Plaintiff”, “Judge”, and “Jury”. These are similar to the same roles in sovereign courts, but not the same.

A “Judge” manages the court and sets the schedule and goals for completing a final verdict. The Judge may step the Jurors through the questions to be answered to complete a final verdict.

The Judge also accepts a case to court that he will try. One Judge may also suggest that an accepted case be merged into a class case and may appeal to the class case Judge to accept the individual case into the class.

A “Juror” in this private, non-sovereign, court system is akin to an arbitrator in that he can ask questions of the Plaintiff and provide additional evidence available off the Internet to be further adjudicated by all the court.

The Plaintiff can only provide additional evidence if specifically directed by the Judge. The Judge can reject evidence if there is reasonable suspicion in the court that the additional evidence is not truthful.

If the suspect liar is present, he is regarded as another Plaintiff with the same burden of proof and suggested verdict required as the first Plaintiff.

A Plaintiff can reopen a case with admission by the Judge at any time with additional pleadings.

The verdict itself, because it is not a judgement on people, can have multiple alternative judgements with different likelihoods assigned by Plaintiffs and Jurors, and different suggested verdicts about truth, deceit, motivation and social acceptability reliefs.

Automated Adjudication

A well-known problem with sovereign courts is the calendar time and human effort they require.

The present method and system can be structured by the court system to yield a rapid result since we are not asking the court to judge against a defendant but rather to develop a managed consensus with a judge to set the time and content rules. Generally it is expected a case can be fully tried in about two weeks from a plaintiff suit being accepted by a judge to the court to be tried.

But there is additional efficiency based on machine learning modules that have a long history in Artificial Intelligence which can be tailored to the actions of the court. This has to do with when actual humans have advantages and the ability of humans to audit the performance of a court that has been, potentially, fully automated.

The technology and mechanism that is brought to this additional automation has been developed already to acceptable levels of capability. Certain companies such as Google, IBM, Apple, Amazon, Facebook, and others include large scale open source efforts such as in Bornstein, Aaron. Open Source NLP tools. https://medium.com/microsoftazure/7-amazing-open-source-nlp-tools-to-try-with-notebooks-in-2019-c9eec058d9f1. These already embody the required Artificial Intelligence machine learning and natural language expertise to create and supply the needed automation modules. These modules can be tailored to accelerate the components of the present system with machines instead of humans for a portion of the individual cases managed by the court.

The present system identifies discrete opportunities for acceleration. In other words, while the methods and systems supplied for Artificial Intelligence modules are not claimed in the present invention, their particular inputs and outputs are, and are defined in this embodiment.

The present method and system is designed to have cases that can be fully discovered and adjudicated in a matter of seconds while retaining full human audit through the stages of a case through the court.

This feature of the method and system is critical to having an immediate effect on the lies, misinformation, and disinformation appearing in digital media by discovering fiat lies, and revealing them for judgement and curation by the digital media.

A final significant aspect of lies, misinformation, and disinformation in digital media is the need to identify the lies quickly. With normal means of determining truth, such as science and sovereign law, it can take years to prove a lie among people. The present invention provides a means to identify a lie's details in a fraction of a second.

This is a major difference between this court and any other known private or public court. This difference shapes the court into a particular relationship among people who participate in the dialogue. A result of this relationship provides a unique and important method and system for training and using machine automation in exposing fiat lies as conversational lies at high speed.

The method and system employs humans which may be replaced in parts by automation in order to make a case exposing a lie that may take a few weeks purely with humans on the Internet, down to under a second with full automation.

Each major sequence of operations of this system may or may not be mechanized in a particular implementation. The major operations are:
1) Fiat lie identification and accusation with context and markup.
2) Structuring dialogue to investigate the fiat lies in order to convert them to conversational or folk lies that can do less harm.
3) Application of the judgement records to similar lies that may be occurring in digital media.

Defeasibility

Court verdicts, even sovereign court verdicts that take many years to adjudicate, are notoriously defeasible. Courts can be wrong.

This means of coming to a conclusion about lies, misinformation, and disinformation in the media is a defeasible outcome like all sovereign and private court verdicts. More information can be found in Danks, David. “The Ethics of Deep Fakes.” Talk at the Carnegie Mellon University Ideas Center on Disinformation, Nov. 19, 2019. https://scs.hosted.panopto.com/Panopto/Pages/Vieweraspx?id=34b710df-20e6-403a-b681-ab03010c664b&start=undefined.

A well-known weakness of courts as everyone knows is that one particular court, with a particular judge and jury may not be as accurate as another at the tasks of identifying lies and reaching judgement.

The machine learning option in the present method and system improves court consistency when the machine learning module applies with high confidence in predicting a human response.

Also because it is not necessary to decide a single attribute of the lie, such as a single untruth, deceit, motivation, or social acceptability decision, the defeasibility is reduced over sovereign or other private court verdicts.

Defeasibility is further reduced because a fiat lie can be reopened at any time without regard to any punishment meted out of a person or harm to any person.

The effect of reopening the case is that the evidence can be updated and the verdict updated without the liar and only with the current state of the lie, or the class of lies, in the media. In effect, the defeasibility has intrinsically less harm than in a sovereign or private court case that judges people.

This reduced defeasibility is an improvement by trying suspected lies, not suspected liars, in the Internet Court of Lies.

The verdict and record of the case can be organized and immediately dispensed through digital media of all kinds, including search engines, social media, and research media in a fully automated fashion. Generally speaking the Plaintiff pleading, but not the verdict, will often be sufficient to detect the recurrence of a lie, while the verdict may then be solicited by the court customer for their own editorial decisions.

The Internet Court of Lies is not a fact finding technology. It manages the fact finding by people and machines. It is a court case management method and system. This approach emphases the management of defeasibility directly.

As another example of this difference in defeasibility consider the problem of determining if the deceit is intentional. In the case of trying people who may be lying, the problem of deciding actual intent is far more difficult because the judgement of intent can harm people. But if the lie is in a context where intent is highly suggested to the court that views it, then the lie itself may be neutralized by simply judging intent. It is not necessary to prove an unknown liar actually had the intent, just that the lie itself, in context, shows intent.

The technical problem, and the basis for the present method and system, is to provide an efficient court system which can take fiat lies, even in large numbers, and rapidly, often instantaneously, resolve them as folk lies. The result is the deceit can often be exposed and understood for what it is, whether that deceit is for good or bad.

As [1][2] and [5] illustrate, lies that deceive do not have to be untruths. This is especially true of modern advanced disinformation and misinformation systems that have access to privacy sensitive information and thereby the ability to tailor the disinformation and misinformation to individual groups of people.

Indeed, [5] has gone so far as to suggest that the globally implicit assumption in sovereign international and national law that assumes every person is his own agent and is responsible, no longer applies against sophisticated digital media schemes to deceive and mislead people. [5] therefore suggests a new fundamental right that can be constitutional law: an inalienable right to agency. The present invention addresses even the problem of lying attacks on human agency itself and provides a means to detect attacks on agency which no other method and system is likely to possess.

Thus we solve the N−1 problem with a method and system for managing individual collectors of fiat lies, a variably sized small jury for dialogue, and individual distributors of verdicts. Verdicts are based on evidentiary information available to anyone where the verdicts include multiple, and not unary, views on the resultant conversational folk lies that have been identified.

### Some Embodiments

The purpose of court dialogue about fiat lies is to reveal them as folk lies and to best complete questions standard for any folk lie. These questions do not address harm to humans in the decision tree because this court only tries fiat lies. Indeed, it is designed mainly to try fiat lies, ex parte, or without the liar present. Rather the jury provides a verdict of different possibilities for the lie components with different likelihoods. In effect, this uses humans to use their judgement gained through enforced moderated dialogue as with any court.

The demonstrated embodiments are illustrated in the English language, but the method and system applies to any human language, since every human language applies perfectly with the method and system.

The science is unambiguous that any human natural language is simply an interface to intermodal cortical processing where lies, deception, motivation, and social understanding is processed in every human in the same ways no matter what their natural language for communication happens to be.

By extension lying and its properties are an intrinsic universal of human neocortical intermodal processing and only human natural language can fully express the lies, misinformation, and disinformation that humans can conceive.

This extension of the embodiment to any human natural language includes the Internet and digital media employing any natural sensory motor communication modality, the claims of lying, evidence, and verdicts reached, as well as the dialogue achieved or machine inferred by the method and system.

The system always provides at least one natural human language interface at each step suitable for examination or audit by any human that speaks that natural language even when fully automated. This is a natural property of the AI Machine Learning Natural Language modules referenced.

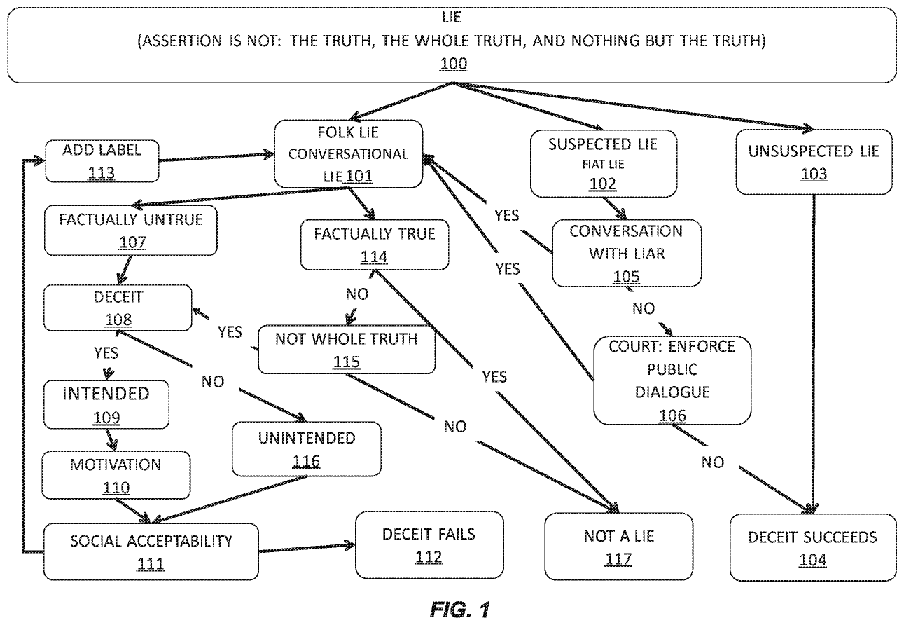

FIG. 1 shows a means of placing any lie, at time t, into a taxonomy of lies. This is a decision network that classifies lies into a hierarchy and not the taxonomy itself.

A lie is determined using the well-known legal definition of truth. That is, an assertion is a lie if it is not the truth, the whole truth, and nothing but the truth 100.

A conversational (or folk) lie 101 is the kind that people recognize is a lie and know its attributes for good or bad. Suspected lies for which dialogue is infeasible for any reason whatsoever will be categorized as fiat lies in operation 102.

The objective of the present method and system is to put truth to fiat lies to determine if they are not lies, or, if they are lies, what kind of conversational, or folk, lie they are. The method and system may not detect a lie at all 103, in which case the deceit will succeed 104. Without any suspicion of a lie, the present system will fail to detect the lie, and the science says that this is always possible and will happen. There can be no perfect solution to detecting lies in the media.

To convert a fiat lie 102 into a folk or conversational lie 101, it is necessary to answer some questions about it. First, in operation 105 we distinguish if conversation about the suspect lie with the liar is indeed infeasible. Some people may be able to have that conversation, others not. If it is feasible, then conversation can begin as a folk lie 101. If not, then the present method and system is to create a court case to enforce moderated dialogue about the fiat lie 106 in order to determine its probable attributes as a folk lie.

If direct dialogue 105 or court enforced dialogue 106 fails the deceit succeeds 104.

The function of the court is to classify the elements of the conversational folk lie. The elements determine if the lie is factually untrue 107, what the deceit is 108, whether it was intended by the liar 109, what his motivation for the deceit was 110, and whether it is socially acceptable 111. Operation 113 provides the option to provide a predicating label on the lie that can change the verdict for social acceptability 111. If a label is provided, then the entire set of conversational lie questions are also answered in the context of this label. This provides a verdict without a label, and additional verdicts with as many labels as have been considered by operation 113.

With any outcome from operation 111 the deceit will fail as asserted by operation 112 in light of the verdict. If they are partially answered, or answered with low likelihood, the deceit may still fail, but it is less certain.

A lie, by its definition, can also be factually true 114. It may then be deemed as not the whole truth 115, in which case it enters the conversational lie decision network at 108 to complete its assignment in the taxonomy. If it is both the truth and the whole truth, then it will be deemed not a lie 116.

Finally, for fiat lies, it may be, and often is a deceit for which the lie is decided as unintended 115. The evidence may suggest that the lie is just being relayed by an unsuspecting liar. This means that the deceit 108 is at best guessed, but the motivation 110 and social acceptability may still be clear 111. Here again, even if a lie is unintended, the deceit, whatever it is, may still fail 112, because motivation or social acceptability may be revealed.

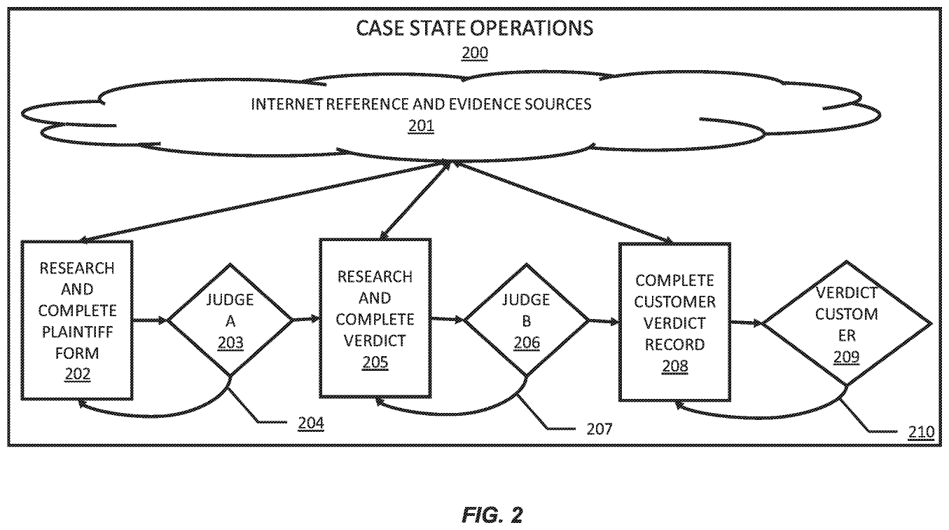

The Case State Diagram 200 in FIG. 2 illustrates the life of a case. The source of a lie may be any digital media where dialogue with the suspect liar is infeasible. Evidence must be documented on the Internet media through the operation of the Internet 201. Since the Internet Court of Lies only tries lies, and not people, the court does not provide for or require witnesses or people at fault. Cases by default are tried ex parte. If a suspected liar who is a known human desired to defend his suspect lies, he can do so by filing as a second Plaintiff in the case and make his counter case just as the primary plaintiff made his.

A case proceeds through three states involving six operations shown in 200. Each operation can be done by a human or a machine.

The first operation involves obtaining a new case GUID from the system 200 or using an existing case with a Plaintiff and filing a Plaintiff case. Operation 202 shows researching and filling out the plaintiff information based on the Internet 201, and the plaintiff's desired verdict. This filled out information and desired verdict is reviewed by a Judge assigned to the case in operation 203, and potentially referred back to the Plaintiff in operation 204. If Judge A accepts the case for adjudication in phase 205, the case is either tried or submitted to a class action that already exists based on the conditions established by the class action case. Judge B operation 206 may also refuse admittance to the class in operation 207.

Judge A in 203 and B in 206 are different humans since bias that may be introduced by having the same judge judge a plaintiff submission and a case submission to a class. In operation 206, Judge B may also accept a recommendation by Judge A, not the Plaintiff, that the case need not be tried by Judge A but be accepted for inclusion in the class with appropriate adoption of selected aspects of the verdict already required by the class. This process can bypass the need for a jury in the original submission 202 accepted by Judge A in 203.

There is no restriction that an individual case filed by a Plaintiff need to be a member of only one class action case as accepted by Judge B.

In operation 206, Judge B may also require that Judge A try the case with a Jury. Any verdict accepted by a class may not be the same as the original one pled by the Plaintiff but must be acceptable to the Plaintiff or overridden and accepted by a Jury.

If Judge A tries the case, then Jurors are selected for the trial phase of the case 205.

The Complete Customer Verdict Record in operation 208 is assembled with oversight by Judge B. Judge B and the System 200 can tailor the verdict record to a particular customer or consumer of that court record. In operation 209, a Verdict Customer of the court record may request additional data from the court on the case as shown in operation 210.

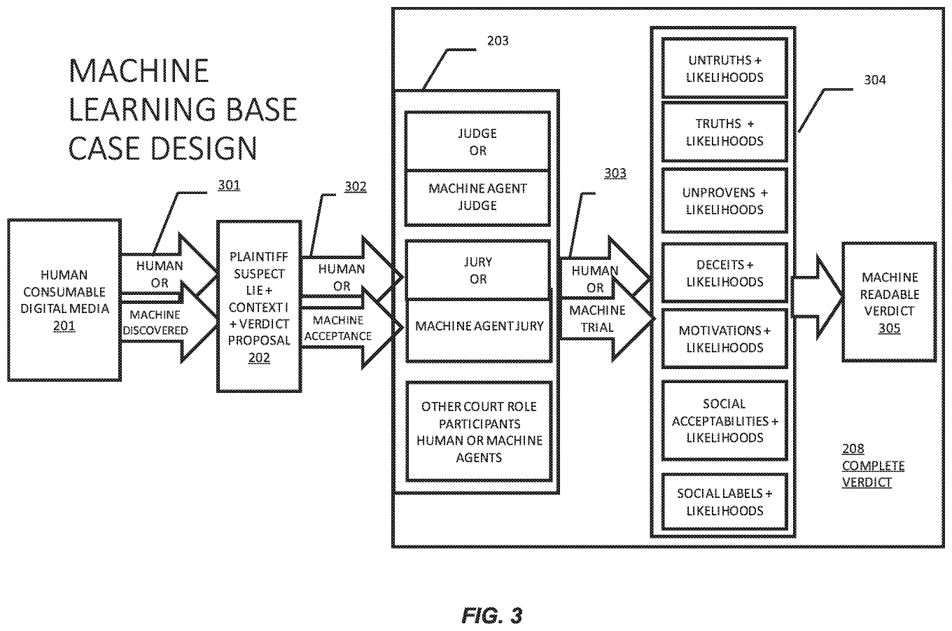

FIG. 3 shows the basic case flow operation 300 incorporating the options for machine or human participation. The first objective is to fill out a plaintiff form based on digital media records available on the Internet in 201. Operation 301 shows this can be done by a human plaintiff in operation or a machine agent plaintiff. The plaintiff must completely document a lie or a sentence that describes a lie or other understanding of a fiat lie or coherent episode of fiat lies that can be described by a single natural language sentence.

Similarly operation 302 shows either human or machine agent acceptance of a Plaintiff case 208 for trial. This includes assigning humans or machine agents for the trial.

Operation 303 shows completing the verdict 208 can be by human or machine agent. The result of the verdict is a machine readable verdict 305. The entire verdict includes the Plaintiff pleading as well as the judgements about truth, deceit, motivation, social acceptability, and labelling associated with the folk interpretation of the fiat lie present to the court.

The lie may be a single fiat lie, or a pattern of fiat lies for which a case is being made. In the pleading the plaintiff must document where and when this fiat lie or pattern is observed. Optionally, it may document why dialogue with the liar to resolve the fiat lie as folk lie is infeasible.

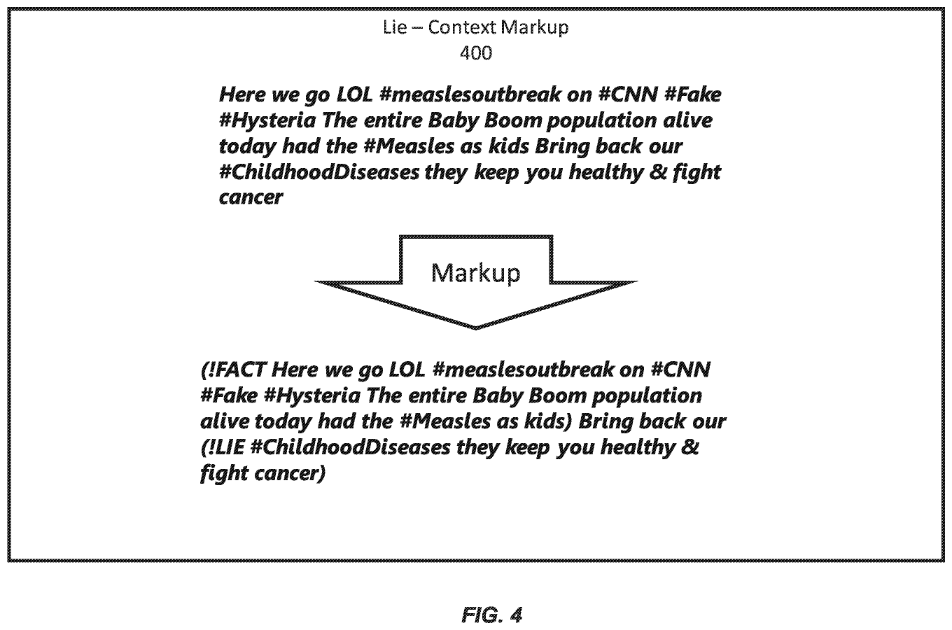

Furthermore, as evidence in the pleading, FIG. 4 demonstrates the operation 400 making explicit the lie and factual contextual markup. In the example of FIG. 4, the markup is (!FACT.) for components of the lie that are factual, (!LIE.) for components of the lie which fail the tests of truths, and no markup where content is regarded as unproven or irrelevant. The particular markup symbols are arbitrary but chosen as “(!FACT.)” and “(!LIE.)” in this embodiment so as not to interfere with Wikitext in a Wikimedia or other HTML or XML implementation. A lie or pattern need not be purely textual in natural language, but may combine pictorial and other modal components and these may be similarly part of the markup.

There is no requirement that the case made by the Plaintiff be exhaustive, since the objective of the court is to convince humans of the claimed properties of the folk or conversational lies as the Plaintiff proposes in his version of the verdict.

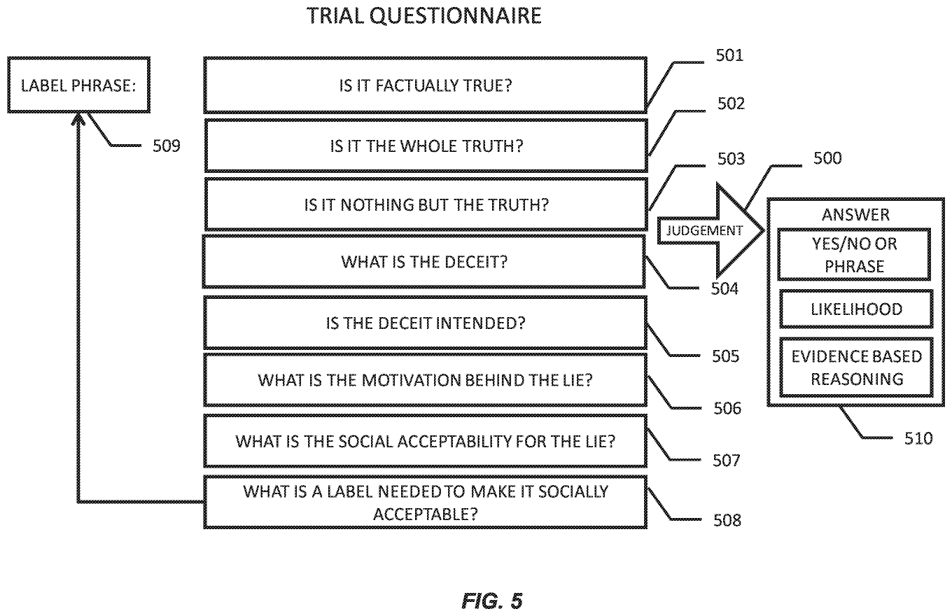

FIG. 5 illustrates the trial questionnaire. The trial is settled and a machine readable verdict 305 reached when the Judge A 203 is satisfied with the judgements made by the Jury. Judge A sets the rules for the trial including number of Jurors and participation rule for Plaintiff, Jurors, and other court roles, as well as timing and meetings including meeting with open dialogue among participants through questioning controlled by the judge.

The query operations 501-509 provide one or more records depending on the number of jurors and plaintiffs and the number of different verdict answers to each question. Each such verdict record in operation 510 contains a Yes/No or Phrase, an estimated likelihood of being true, and any evidence based reasoning supplied by the jurors or plaintiffs supporting the verdict.

Scalar verdict questions may be each be given more than one answer by each juror and each plaintiff. So, for example, a single juror may believe there is more than one deceit. For each deceit he judges from the evidence, he provides an estimate of the likelihood of its truth in his judgement as well as any evidential reasoning he can supply.

As another example, a juror may indicate a lie violates more than one of the measures of the lie that it is untrue, not the whole the truth, or justified by untruths. A lie may be true but not the whole truth. It may be true and not the whole truth. It may be true based on untruths with one judged likelihood and untrue with another, but the two likelihoods may not add up to 100%. The likelihoods are human estimates of a verdict's truth and need not add to any particular total.

The social acceptability of the lie is Yes or No, with likelihood and evidential reasoning if available in the judgement of each plaintiff or juror in his judgement.

The additional query operation 508 and label request operation 509 is for a contextual label for the lie to make it socially acceptable. For example, it may be that if the liar simply labelled the lie “a vile lie” or “just fiction”, it would be more socially acceptable. If a label is suggested the judge may ask that all respondents answer the questions again but in the context of a (!FACT label) predicating the whole lie.

In the verdict this is recorded to show what label or labels could change the other decisions of the verdict, and how, if the label is clearly presented as context for the lie where it occurs in the media. The label may be any assertion of fact under which the lie may be re-judged. The verdict, however, contains all the judgements under all contexts the Judge permits or directs to be made in his assembly of the verdict for the customer in operation 305.

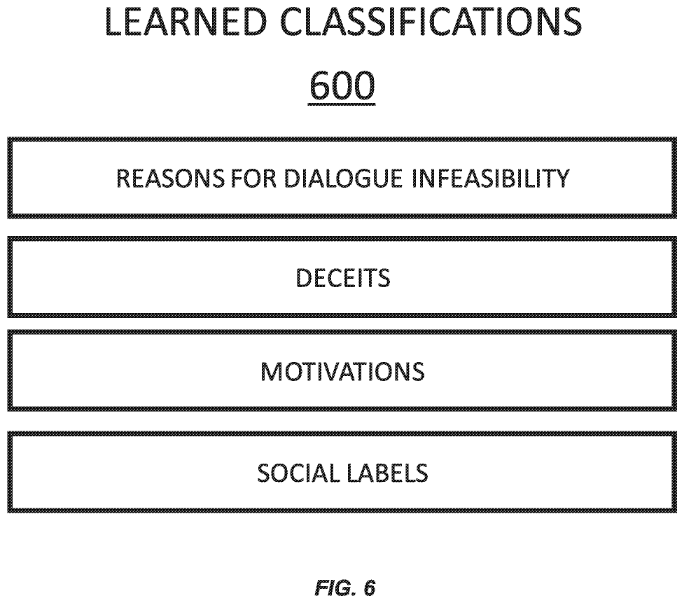

FIG. 6 shows the Learned Classifications 600 for the machine learning automation. These are scalar assertions made over all cases judged by the Internet Court of Lies which may be employed by reference either by human judges and jurors or machine judges and jurors.

There are four types of such assertions in the present embodiment. To be useful these assertions should not be specific to a particular case, but rather describe general reasons for dialogue infeasibility, general kinds of deceits, general kinds of motivations, and general kinds of social labels. For example, a motivation “to gain political advantage” is more useful than a motivation that provides detail as in “a lie about sexual preference of the political opponent to gain political advantage.” It is assumed that this additional detail will be obvious in the markup of the lie in operation 400.

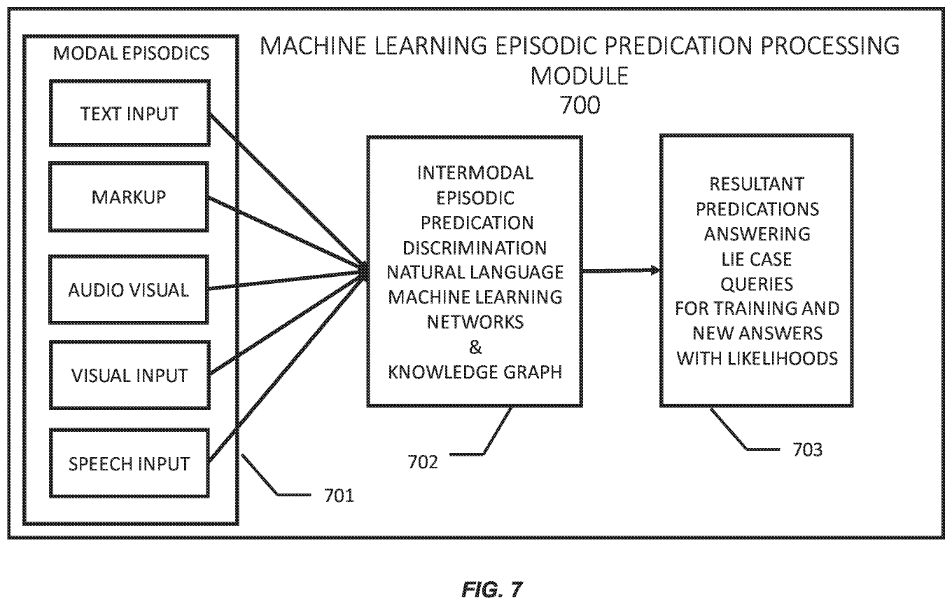

FIG. 7 shows the operation of the machine learning and natural language systems modules employed in the present system. The operation 700 is on modal episodic predications such as text, markup, visual, audio, speech inputs and outputs in operation 701 and intermodal episodic predication processing on these for the various human tasks defined in the court which are alternatively human or machine tasks in operation 702. In particular, the Intermodal capability must incorporate predication contextuality required to handle lies of all kinds and understanding and production of natural language inputs and outputs. Operation 703 shows outputs for various questions and answers along with verdict answers with likelihoods estimates to be correct for humans by the machine learning.

The technical know-how in building such modules has been demonstrated by a number of companies although it would be expected that technically different modules will be required to handle the automation of all the automation tasks required by the present system and method.

In particular, the most unconstrained task is the task of performing the plaintiff role of identifying suspected lying for which dialogue is infeasible. So, for this plaintiff pleading component of the Court, humans may be employed even while other automation tasks are otherwise justified for use. Juror judgements in answering questions in trial may be estimated accurately by machine learning.

Which automation modules are employed in a particular stage of the court case depends on whether that component can provide an answer with high confidence of accurately predicting the human cognitive language descriptions. In the colloquial of commercially available technologies, there are several Alexa, Siri, or Cortana specializations, not one, required by the present method and system. In exchange, the present method and system provide training data for these systems to be tailored to being competent about human lying, disinformation, and misinformation.

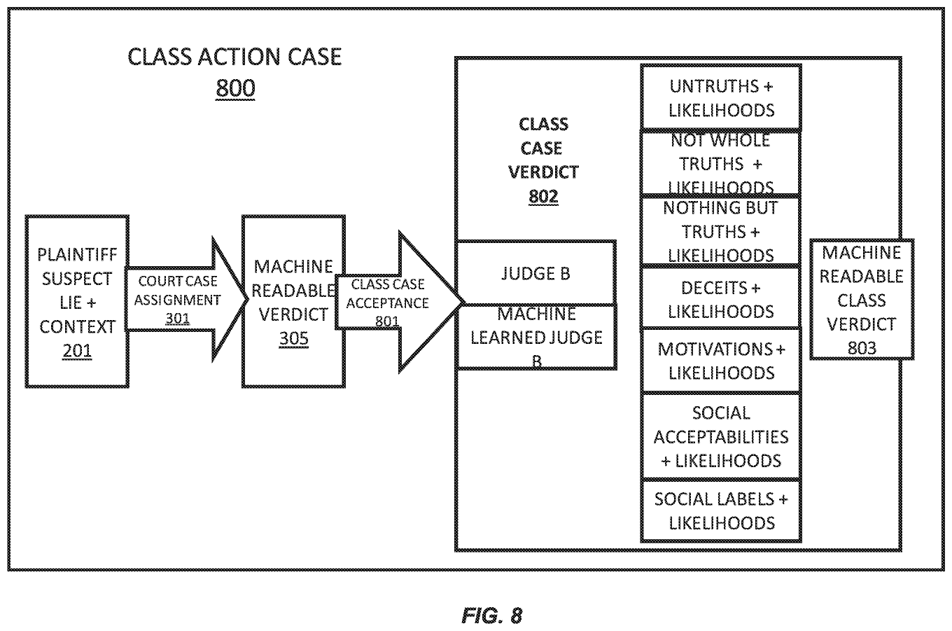

FIG. 8 shows the operation of the special class action case 800. One or more basic cases in FIG. 3 operation 300, operations 205, 301, and 305 may be admitted to a class action case in operation 801. In a class case verdict operation 802 the verdicts, but not the full pleadings of multiple plaintiffs are combined, and a class case may not employ all the verdicts in order to depict the class conclusions in 803. For example, one class may be for all lies told by a public figure, and another class told for all lies regarding medical vaccines. With classes, a customer may search pleadings in 300 for lie occurrences, and then request from a class an overall verdict representing a number of individual pleadings that share verdicts. Judge B is overseeing this operation in the verdict in 803.

Since the Internet Court of Lies tries Lies and not people, the system by default assures anonymity of the human participants. This also insures that people may bring truth to lies even against their personal preferences.

The method and system implement a penalty against a plaintiff, judge, or juror himself caught in a fiat lie or the use of an unauthorized robot. This penalty is banning from further involvement in the court system.

In effect, if a plaintiff, judge, or juror lies in his pleading or judgement, or is not human when expected to be, the system has the recourse to ban that individual or organization from participation in the system. Determination of such fiat lying can be brought in a separate case in the court system. Note, that during a trial, if a lie is suspected by some participant, the participant must be willing to converse about it. His unwillingness to converse about it would be grounds for trying it as a fiat lie. Cases can be rapidly retried when court participant lying is caught.

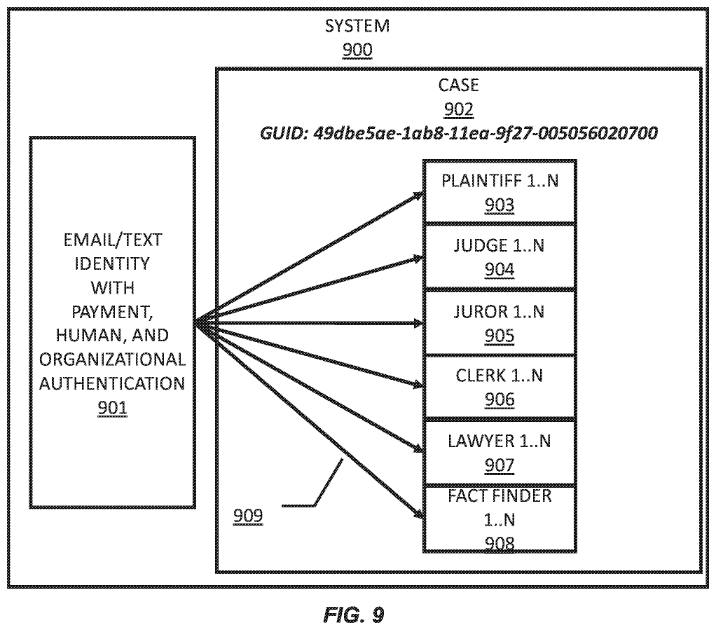

The method and system illustrated in 900 in FIG. 9 provides an operation to require humans have globally unique email addresses which insures the system has a means to confirm they are human or reasonably known to be human in operation 901.

The lie cases are assigned a Globally Unique ID illustrated in 902, and within each lie case, the human roles of Plaintiff 903, Judge 904, Juror 905, Clerk 906, Lawyer 907, and Fact Finder 908 are assigned sequential ascension, 1 . . . n, as used in that particular case 902 by operation 909.

Where and when the system employs humans, the System 900 thus utilizes a means of identification that insures a default assurance of anonymity illustrated in FIG. 1. Human agents that may replace specific humans in roles are identified in the same ascension labelling by operation 909.

Thus, the participants in a case cannot know the identity of the other humans or agents in the case, except indirectly by this standard designation, and across cases a name does not correlate with any particular human or agent identities except by chance.

The Plaintiffs 903 are the only roles that are self-selected in that any Plaintiff can request a new case for himself and thereby be “Plaintiff 1” for that particular case. The other roles are assigned randomly by the system to qualified humans who have agreed to be in the selection pool for that role. The system guarantees that no human, defined by a validated email or text address, can participate in any more than one role throughout the life of the particular case. Machine agents are all selected as appropriate to the assigned roles.

The default anonymity of human participants should not imply that participants are prevented from revealing themselves on their own volition outside of the operation of the system. A notable example would be a case about a lie where the liar is publicly known to be the suspect liar, or a case where the suspect liar is revealed in a Plaintiff 903 pleading based on evidence or through evidence introduced by a Juror 904.

It will be seen that there are many variants on the above embodiment or that only parts of the embodiment are required to improve the art.

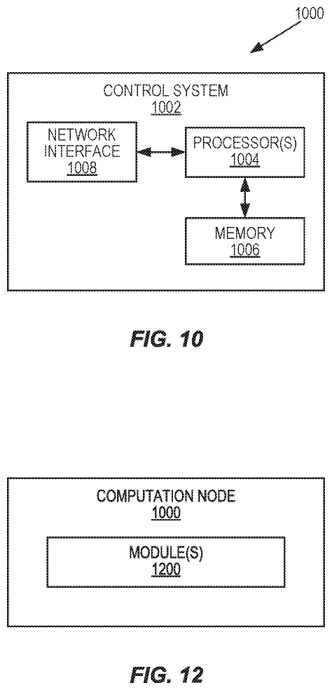

FIG. 10 is a schematic block diagram of a computation node 1000 according to some embodiments of the present disclosure. Optional features are represented by dashed boxes. The computation node 1000 may be, for example, a server, a virtual machine, a container or pod running on a cloud node, or any other computation system. As illustrated, the computation node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. The one or more processors 1004 operate to provide one or more functions of a computation node 1000 as described herein. In some embodiments, the function(s) are implemented in software that is stored, e.g., in the memory 1006 and executed by the one or more processors 1004.

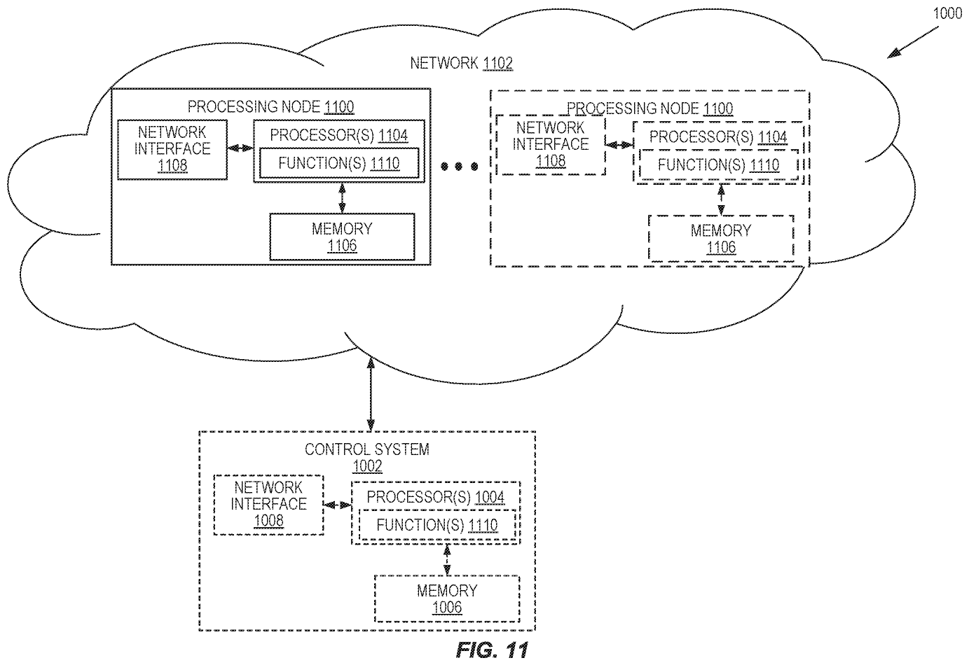

FIG. 11 is a schematic block diagram that illustrates a virtualized embodiment of the computation node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” computation node is an implementation of the computation node 1000 in which at least a portion of the functionality of the computation node 1000 is implemented as a virtual component(s) (e.g., via a virtual machine(s) executing on a physical processing node(s) in a network(s)). As illustrated, in this example, the computation node 1000 may include the control system 1002, as described above. The computation node 1000 includes one or more processing nodes 1100 coupled to or included as part of a network(s) 1102. If present, the control system 1002 is connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the computation node 1000 described herein are implemented at the one or more processing nodes 1100 or distributed across the one or more processing nodes 1100 and the control system 1002 in any desired manner. In some particular embodiments, some or all of the functions 1110 of the computation node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110.

In some embodiments, a computer program including instructions which, when executed by at least one processor, causes the at least one processor to carry out the functionality of computation node 1000 or a node (e.g., a processing node 1100) implementing one or more of the functions 1110 of the computation node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the computation node 1000 according to some other embodiments of the present disclosure. The computation node 1000 includes one or more modules 1200, each of which is implemented in software. The module(s) 1200 provide the functionality of the computation node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

Those skilled in the art will recognize improvements and modifications to the preferred embodiments of the present disclosure. All such improvements and modifications are considered within the scope of the concepts disclosed herein and the claims that follow.

1. A method for controlling pernicious lies in digital media, the method comprising:
identifying a suspected lie in digital media;
determining a consensual truth of the suspected lie; and
distributing the consensual truth of the suspected lie.

2. The method of claim 1 wherein the suspected lie comprises one or more of the group comprising: lies, misinformation, and disinformation in digital media.

3. The method of claim 2 wherein at least one of the steps comprises a parallel manual and automated method which enables improving automation while sustaining auditability.

4. The method of claim 3 wherein the parallel manual and automated method further enables using a sequence of manual events to train the automation.

5. The method of claim 4 further comprising structuring dialogue to perform at least one of the steps.

6. The method of claim 5 wherein structuring the dialogue is performed manually, automated, or a combination of manually and automated.

7. The method of claim 6 further comprising:
assuring anonymity of humans participating in any of the steps.

8. A computation node for controlling pernicious lies in digital media, the computation node comprising:
processing circuitry configured to:
identify a suspected lie in digital media;
determine a consensual truth of the suspected lie; and
distribute the consensual truth of the suspected lie.

9. The computation node of claim 8 wherein the suspected lie comprises one or more of the group comprising: lies, misinformation, and disinformation in digital media.

10. The computation node of claim 9 wherein at least one of the steps comprises a parallel manual and automated method which enables improving automation while sustaining auditability.

11. The computation node of claim 10 wherein the parallel manual and automated method further enables using a sequence of manual events to train the automation.

12. The computation node of claim 11 further configured to structure dialogue to perform at least one of the steps.

13. The computation node of claim 12 wherein being configured to structure the dialogue is performed manually, automated, or a combination of manually and automated.

14. The computation node of claim 13 further configured to:
assure anonymity of humans participating in any of the steps.

15. A computation node for controlling pernicious lies in digital media, the computation node comprising:
processing circuitry configured to perform any of the steps of claim 7; and
power supply circuitry configured to supply power to the computation node.
